(19) United States
(12) Patent Application Publication
(10) Pub. No.: US 2020/0106821 A1
(43) Pub. Date: Apr. 2, 2020

(54) VIDEO PROCESSING APPARATUS, VIDEO CONFERENCE SYSTEM, AND VIDEO PROCESSING METHOD

(71) Applicant: Koji Kuwata, Kanagawa (JP)

(72) Inventor: Koji Kuwata, Kanagawa (JP)

(73) Assignee: Ricoh Company, Ltd.

(21) Appl. No.: 16/582,285

(22) Filed: Sep. 25, 2019

(30) Foreign Application Priority Data
Sep. 28, 2018 (JP) 2018-186004
May 27, 2019 (JP) 2019-098709

(51) Int. Cl. H04L 29/06; H04N 19/176; H04N 19/154; H04N 7/15; H04N 7/14

(52) U.S. Cl. CPC H04L 65/607; H04N 19/176; H04L 65/80; H04N 7/152; H04N 7/144; H04N 19/154

(57) ABSTRACT

A video processing apparatus includes a memory; and one or more processors coupled to the memory, where the one or more processors are configured to acquire a video; analyze high frequency components, for each of areas of the acquired video; and perform image quality adjustment, in accordance with an analysis result of the high frequency components, such that an image quality of at least a part of the areas of the video increases as an amount of high frequency components in the at least part of the areas of the video increases.

### CROSS-REFERENCE TO RELATED APPLICATIONS

The present application is based on and claims priority to Japanese Patent Application No. 2018-186004, filed on Sep. 28, 2018, and Japanese Patent Application No. 2019-098709, filed on May 27, 2019, the contents of which are incorporated herein by reference in their entirety.

### BACKGROUND OF THE INVENTION

### 1. Field of the Invention

The disclosures discussed herein relate to a video processing apparatus, a video conference system, and a video processing method.

### 2. Description of the Related Art

Patent Document 1 discloses a technology for setting an image quality of an image captured by a surveillance camera such that an image quality of an area where no movement or face is detected is lower than an image quality of an area where movement or face is detected. According to this technology, burden on a transmission channel in the network may be reduced by decreasing a size of encoded data of the captured image as well as improving visibility of the image in the area where the movement is detected.

### RELATED-ART DOCUMENT

### Patent Document

### [PTL 1] Japanese Unexamined Patent Publication No. 2017-163228

### SUMMARY OF THE INVENTION

However, in such a related art technology, in a case where a video is divided into a low image quality area and a high image quality area, the video exhibits a conspicuous difference in an image quality at an interface between the low image quality area and the high image quality area, and a viewer of the video may perceive unnaturalness.

The present invention is intended to reduce the amount of video data and to reduce a difference in an image quality at an interface between the low quality area and the high quality area to make the difference inconspicuous.

According to one aspect of embodiments, a video processing apparatus includes

a memory; and
one or more processors coupled to the memory, the one or more processors being configured to:

acquire a video;

analyze high frequency components, for each of areas of the acquired video; and

perform image quality adjustment, in accordance with an analysis result of the high frequency components, such that an image quality of at least a part of the areas of the video increases as an amount of high frequency components in the at least part of the areas of the video increases.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating a system configuration of a video conference system, according to an embodiment of the present invention;

FIG. 2 is a diagram illustrating an external appearance of an Interactive Whiteboard (IWB), according to an embodiment of the invention;

FIG. 3 is a diagram illustrating a hardware configuration of an IWB, according to an embodiment of the present invention;

FIG. 4 is a diagram illustrating a functional configuration of an IWB, according to an embodiment of the invention;

FIG. 5 is a flowchart illustrating a video conference execution control processing performed by an IWB, according to an embodiment of the present invention;

FIG. 6 is a flowchart illustrating a video processing procedure performed by a video processor, according to an embodiment of the present invention;

FIGS. 7A to 7C are specific examples of video processing performed by a video processor, according to an embodiment of the present invention; and

FIGS. 8A to 8D are specific examples of video processing performed by a video processor, according to an embodiment of the present invention.

### DETAILED DESCRIPTION OF THE PREFERRED EMBODIMENTS

### Embodiment

The following illustrates an embodiment of the present invention with reference to the accompanying drawings.

### System Configuration of Video Conference System 10

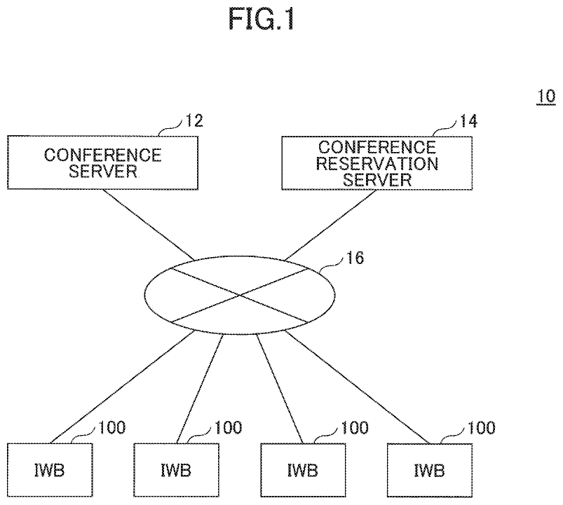

FIG. 1 illustrates a system configuration of a video conference system 10, according to an embodiment of the present invention. As illustrated in FIG. 1, the video conference system 10 includes a conference server 12, a conference reservation server 14, and multiple Interactive Whiteboards (IWBs) 100, which are all connected to a network 16, such as the Internet, intranet, or a local area network (LAN). The video conference system 10 is configured to implement a so-called video conference between multiple locations using the above-described devices.

The conference server 12 is an example of a “server apparatus”. The conference server 12 performs various controls relating to a video conference performed by multiple IWBs 100. For example, at the start of a video conference, the conference server 12 monitors a status of a communication connection between each of the IWBs 100 and the conference server 12, invokes each of IWBs 100, and the like, and during a video conference, the conference server 12 performs transmission of various data (e.g., video data, voice data, rendered data, etc.) between the multiple IWBs 100.

The conference reservation server 14 manages a status of the video conference reservation. Specifically, the conference reservation server 14 manages conference information input from an external information processing apparatus (i.e., a personal computer (PC), etc.) through the network 16. Examples of the conference information may include dates, venues, participants, roles, terminals, etc. The video conference system 10 performs a video conference based on conference information managed by the conference reservation server 14.

The IWBs 100 each represent an example of a “video processing apparatus”, an “imaging device” and a “communication terminal”. The IWBs 100 may each be a communication terminal installed at each location where a video conference is held and is used by video conference participants. For example, the IWBs 100 may each be enabled to transmit various data (e.g., video data, voice data, rendered data, etc.), which have been input during a video conference, to other IWBs 100 via the network 16 and the conference server 12. Further, the IWBs 100 may each output various data transmitted from other IWBs 100 according to types of data (e.g., display, output of voice, etc.) to appropriately present the various data to video conference participants.

### Configuration of the IWB 100

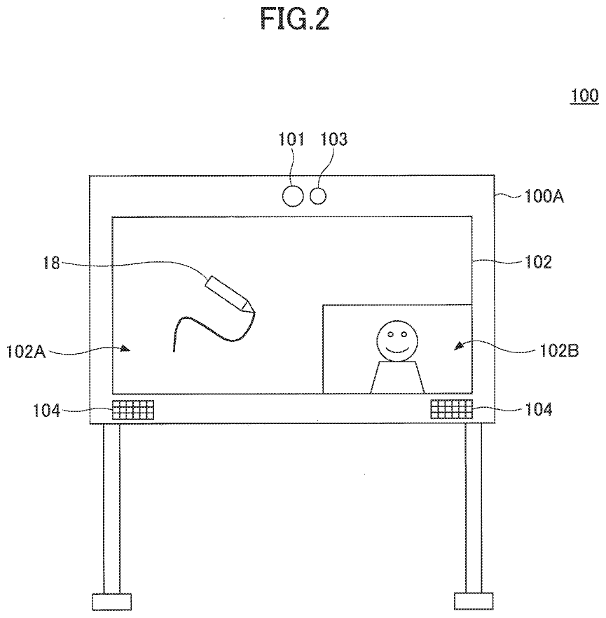

FIG. 2 is a diagram illustrating an external appearance of an IWB 100, according to an embodiment of the invention. As illustrated in FIG. 2, the IWB 100 includes a camera 101, a touch panel display 102, a microphone 103, and a loudspeaker 104, on a front face of its main body 100A.

The camera 101 captures a video in front of the IWB 100. The camera 101 includes, for example, a lens, image sensors, and a video processing circuit such as a digital signal processor (DSP). The image sensor generates video data (RAW data) by photoelectric conversion of light collected by the lens. Examples of the image sensor include a Charge Coupled Device (CCD) and a Complementary Metal Oxide Semiconductor (CMOS). The video processing circuit generates video data (YUV data) by performing typical video processing on video data (RAW data) generated by the image sensor. The typical video processing includes Bayer conversion, 3A control (AE: automatic exposure control, AF: auto focus, and AWB: auto white balance), and the like. The video processing circuit outputs the generated video data (YUV data). The YUV data represents color information by a combination of three elements, that is, a luminance signal (Y), a difference (U) between the luminance signal and a blue component, and a difference (V) between the luminance signal and a red component.

The touch panel display 102 includes a display and a touch panel. The touch panel display 102 displays various types of information (e.g., video data, rendered data, etc.) via a display. The touch panel display 102 also inputs various types of information (e.g., characters, figures, images, etc.) through a contact operation with an operating body 18 (e.g., fingers, pens, etc.) via the touch panel. As a display, for example, a liquid crystal display, an organic EL display, an electronic paper, or the like may be used. As a touch panel, a capacitance touch panel may be used.

The microphone 103 collects voice around the IWB 100, and generates voice data (analog data) corresponding to the collected voice. The microphone 103 then converts the collected voice data (analog data) into voice data (digital data) (analog-to-digital conversion) to output the voice data (digital data) corresponding to the collected voice.

The loudspeaker 104 is driven based on voice data (analog data) to output a voice corresponding to the voice data. For example, the loudspeaker 104 may output a voice collected by an IWB 100 at another location by being driven based on the voice data transmitted from the IWB 100 at the other location.

The IWB 100 configured in this manner performs later-described video processing and encoding processing with respect to video data acquired from the camera 101 so as to reduce the amount of data. Thereafter, the IWB 100 transmits, to other IWBs 100 via the conference server 12, the video data together with various display data (e.g., video data, rendered data, etc.) acquired from the touch panel display 102 and voice data acquired from the microphone 103. This configuration enables the IWB 100 to share these data with other IWBs 100. In addition, the IWB 100 displays display contents on the touch panel display 102 based on various display data (e.g., video data, rendered data, etc.) transmitted from other IWBs 100, and outputs a voice from the loudspeaker 104 based on the voice data transmitted from other IWBs 100. This configuration enables the IWB 100 to share these data with other IWBs 100.

For example, in the example illustrated in FIG. 2, a display layout having multiple display areas 102A and 102B is displayed on the touch panel display 102. The display area 102A serves as a rendering area that displays data rendered by an operating body 18. The display area 102B displays a video captured by the camera 101 at a location of the IWB 100 itself. The touch panel display 102 may display rendered data rendered by another IWB 100, or a video and the like captured by another IWB 100 at another location.

### Hardware Configuration of the IWB 100

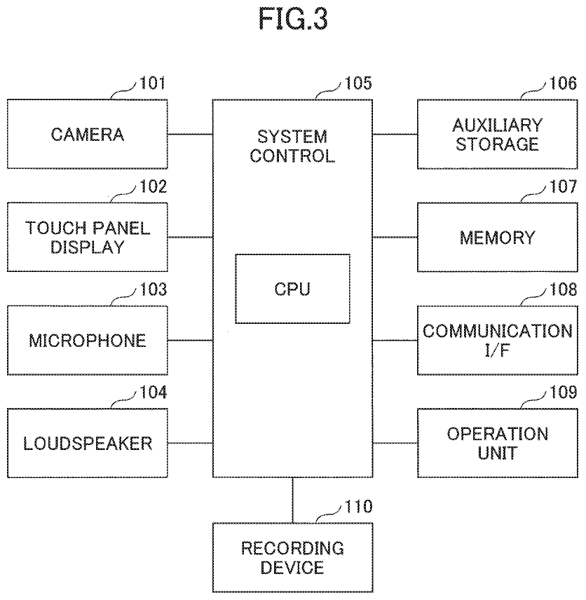

FIG. 3 is a diagram illustrating a hardware configuration of the IWB 100, according to an embodiment of the present invention. As illustrated in FIG. 3, the IWB 100 includes the camera 101, the touch panel display 102, the microphone 103, and the loudspeaker 104 that have been described in FIG. 2, and the IWB 100 further includes a system control 105 having a CPU (Central Processing Unit), auxiliary storage 106, memory 107, a communication I/F 108, an operation unit 109, and a recording device 110.

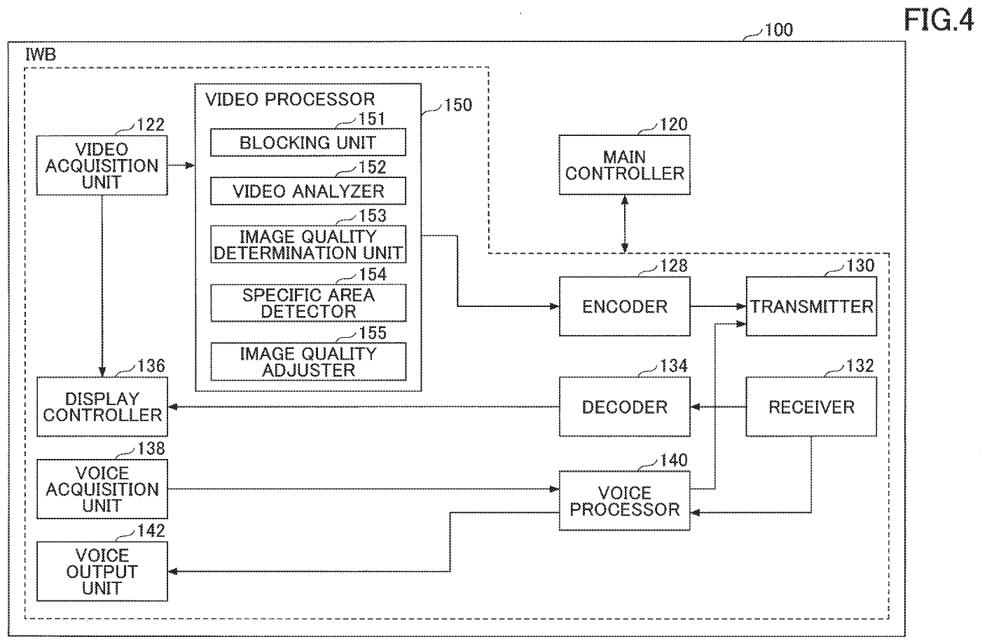

The system control 105 executes various programs stored in the auxiliary storage 106 or the memory 107 to perform various controls of the IWB 100. For example, the system control 105 includes a CPU, interfaces with peripheral units, a data access adjustment function, and the like. The system control 105 controls various types of hardware included in the IWB 100 to perform execution controls of various functions relating to a video conference provided by the IWB 100 (see FIG. 4).

For example, the system control 105 transmits video data acquired from the camera 101, rendered data acquired from the touch panel display 102, and voice data acquired from the microphone 103, to other IWBs 100 via the communication I/F 108 as a basic function relating to a video conference.

Further, the system control 105 causes the touch panel display 102 to display a video based on video data acquired from the camera 101, and rendered content based on rendered data acquired from the touch panel display 102 (i.e., video data and rendered data at the location of the IWB itself).

In addition, the system control 105 acquires the video data, the rendered data, and the voice data transmitted from the IWB 100 at another location through the communication I/F 108. The system control 105 causes the touch panel display 102 to display a video based on video data, and rendered contents based on rendered data, and also causes the loudspeaker 104 to output a voice based on voice data.

The auxiliary storage 106 stores various programs to be executed by the system control 105, and data necessary for the system control 105 to execute various programs. Non-volatile storage such as flash memory, HDD (hard disk drive), and the like are used as the auxiliary storage 106.

The memory 107 functions as a temporary storage area used by the system control 105 upon execution of various programs. The memory 107 may be a volatile storage, such as a Dynamic Random Access Memory (DRAM) or a Static Random Access Memory (SRAM).

The communication I/F 108 is an interface for connecting to the network 16 to transmit and receive various data to and from other IWBs 100 via the network 16. For example, the communication I/F 108 may be a wired LAN interface corresponding to 10Base-T, 100Base-TX, 1000Base-T, or the like, or a wireless LAN interface corresponding to IEEE 802.11a/b/g/n, or the like.

The operation unit 109 is operated by a user to perform various input operations. Examples of the operation unit 109 include a keyboard, a mouse, a switch, and the like.

The recording device 110 records video data and voice data into the memory 107 during a video conference. In addition, the recording device 110 reproduces video data and the voice data recorded in the memory 107.

### Functional Configuration of the IWB 100

FIG. 4 is a diagram illustrating a functional configuration of an IWB 100 according to an embodiment of the invention. As illustrated in FIG. 4, the IWB 100 includes a main controller 120, a video acquisition unit 122, a video processor 150, an encoder 128, a transmitter 130, a receiver 132, a decoder 134, a display controller 136, a voice acquisition unit 138, a voice processor 140, and a voice output unit 142.

The video acquisition unit 122 acquires video data (YUV data), which is acquired from the camera 101. Video data acquired by the video acquisition unit 122 is configured by a combination of multiple frame images.

The video processor 150 performs video processing on video data acquired by the video acquisition unit 122. The video processor 150 includes a blocking unit 151, a video analyzer 152, an image quality determination unit 153, a specific area detector 154, and an image quality adjuster 155.

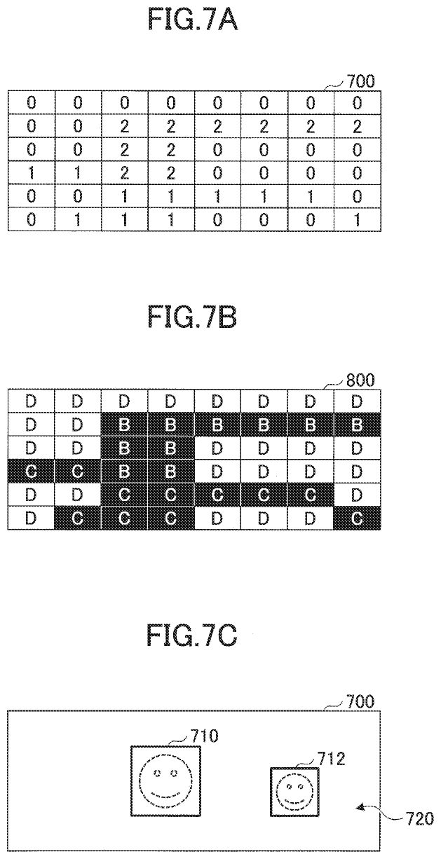

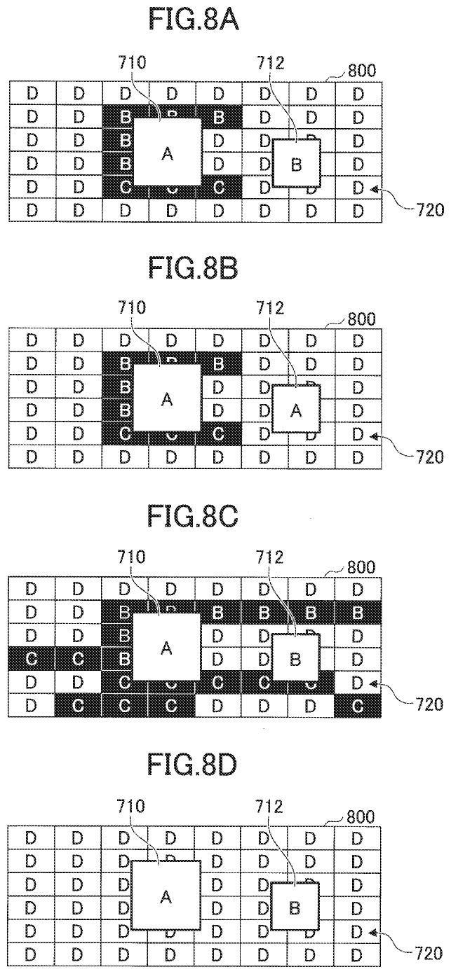

The blocking unit 151 divides a frame image into multiple blocks. In the examples illustrated in FIGS. 7A to 7C and FIGS. 8A to 8C, the blocking unit 151, for example, divides a single frame image into 48 blocks (8×6 blocks). Note that a relatively small number of blocks is used in the above-described examples in order to facilitate understanding of the description. In practice, in a case where the resolution of the frame image is 640×360 pixels (VGA), and one block includes 16×16 pixels, the frame image is divided into 40×23 blocks. In addition, in a case where the resolution of the frame image is 1920×1080 pixels (Full HD), and one block includes 16×16 pixels, the frame image is divided into 120×68 blocks.

The video analyzer 152 analyzes high frequency components for each of the multiple blocks. Note that “to analyze high frequency components” means to convert the amount of high frequency components into a numerical value. A high frequency component represents an intensity difference between neighboring pixels that exceeds a predetermined threshold. Specifically, in the frame image, an area with a small amount of neighboring pixels having a high intensity difference (i.e., intensity difference higher than the predetermined threshold) indicates an area with a small amount of high frequency components, and an area with a large amount of neighboring pixels having the high intensity difference indicates an area with a large amount of high frequency components. To analyze high frequency components, any method known in the art, such as FFT (Fast Fourier Transform), DCT (Discrete Cosine Transform) used for JPEG (Joint Photographic Experts Group) compression or the like may be used.

The image quality determination unit 153 determines an image quality for each of the blocks in accordance with an analysis result of high frequency components. Specifically, the image quality determination unit 153 generates an image quality level map by setting an image quality for each of the blocks, based on an analysis result of high frequency components provided by the video analyzer 152. In this case, the image quality determination unit 153 sets an image quality for each of the blocks, based on the analysis result of the high frequency components by the video analyzer 152, such that an area with a larger amount of high frequency components has a higher image quality. For example, for each block, the image quality determination unit 153 sets one of the four image quality levels that are “A (highest image quality)”, “B (high image quality)”, “C (intermediate image quality)”, and “D (low image quality)”.

Note that as described above, the image quality determination unit 153 is enabled to change the image quality setting in the image quality level map that has once been generated. For example, upon a face area being detected by the specific area detector 154, the image quality determination unit 153 is enabled to change the image quality setting in the image quality level map such that the image quality of the face area is higher than the image quality of other areas excluding the face area. In such a case, the image quality determination unit 153 is enabled to reduce the amount of data in other areas by changing the image quality of these other areas excluding the face area to the lowest image quality (e.g., the image quality “D”).

Further, a first predetermined condition is defined as a condition to determine that a network bandwidth (e.g., the “communication resources used for transmission”) is short of capacity, and a second predetermined condition is defined as a condition to determine that a network bandwidth has extra capacity. In a case where the first predetermined condition is satisfied (e.g., the communication speed is equal to or less than a first predetermined threshold value), the image quality determination unit 153 is enabled to reduce the amount of data in other areas excluding the face area by changing the image quality of these other areas to the lowest image quality (e.g., the image quality “D”). In a case where the second predetermined condition is satisfied (e.g., the communication speed is equal to or more than the second predetermined threshold value, provided that the second threshold value is equal to or more than the first threshold value), the image quality determination unit 153 is enabled to change the image quality of the face area to the highest image quality (e.g., the image quality “A”) to improve the image quality of the face area.

Further, in a case where the image quality determination unit 153 changes an image quality of areas excluding a peripheral area around the speaker's area to “D (low image quality)” upon an image quality level map being generated, the image quality determination unit 153 is enabled to return the image quality of the areas excluding the peripheral area around the speaker's area to the initial image quality set in the initially generated image quality level map.

The specific area detector 154 detects a specific area in video data (frame image) that has been acquired by the video acquisition unit 122. Specifically, in video data (frame image) that has been acquired by the video acquisition unit 122, the specific area detector 154 detects, as a specific area, a face area where a face of a person is detected. To detect a face area, any methods known in the art may be used; for example, a face area may be detected by extracting feature points such as an eye, a nose, a mouth, or the like may be used. The specific area detector 154 specifies, as a speaker's area, a face area where a face of a person who converses is displayed by using any one of known detection methods.

The image quality adjuster 155 performs, pixel by pixel, image quality adjustment with respect to a single frame image, in accordance with a final image quality level map. For example, when one of image quality levels of “A”, “B”, “C”, and “D” is set for each of the blocks in the image quality level map, the image quality adjuster 155 performs, pixel by pixel, image quality adjustment with respect to a single frame image such that a relationship between the image quality levels is represented by “A”>“B”>“C”>“D”. To perform image quality adjustment, any methods known in the art may be used. For example, the image quality adjuster 155 maintains the original image quality for blocks having the image quality setting of “A”. Further, the image quality adjuster 155 lowers, from the original image quality (image quality “A”), the image quality for blocks having the image quality setting of “B”, “C”, or “D” by using any one of known image quality adjustment methods (e.g., resolution adjustment, contrast adjustment, low pass filters, and frame rate adjustment). As an example, no low pass filter is applied to blocks having an image quality setting of “A”, a 3×3 low pass filter is applied to blocks having an image quality setting of “B”, a 5×5 low pass filter is applied to blocks having an image quality setting of “C”, and a 7×7 low pass filter is applied to blocks having an image quality setting of “D”. This image quality adjustment method appropriately reduces the amount of data in the frame image, according to the image quality levels.

The encoder 128 encodes video data that has been video-processed by the video processor 150. Examples of the encoding scheme used by the encoder 128 include H.264/AVC, H.264/SVC, and H.265.

The transmitter 130 transmits, to other IWBs 100 via the network 16, the video data encoded by the encoder 128 together with voice data (the voice data that has been voice-processed by the voice processor 140) acquired from the microphone 103.

The receiver 132 receives, via the network 16, the video data and voice data that have been transmitted from other IWBs 100. The decoder 134 decodes, using a predetermined decoding scheme, the video data that has been received by the receiver 132. The decoding scheme used by the decoder 134 corresponds to the encoding scheme used by the encoder 128 (e.g., H.264/AVC, H.264/SVC, H.265, etc.).

The display controller 136 reproduces the video data decoded by the decoder 134 to display a video (i.e., a video at another location) on the touch panel display 102 based on the video data. The display controller 136 reproduces the video data acquired from the camera 101 to display a video (i.e., a video at the location of the IWB itself) on the touch panel display 102 based on the video data. Note that the display controller 136 is enabled to display multiple types of videos in a display layout having multiple display areas, based on layout setting information set in the IWB 100. For example, the display controller 136 is enabled to display a video at the location of the IWB itself and a video at another location simultaneously.

The main controller 120 performs overall control of the IWB 100. For example, the main controller 120 controls initial setting of each module, setting of the imaging mode of the camera 101, the communication start request to other IWBs 100, the start of the video conference, the end of the video conference, recording by the recording device 110, and the like.

The voice acquisition unit 138 acquires voice data from the microphone 103. The voice processor 140 performs various types of voice processing on the voice data acquired by the voice acquisition unit 138, and also performs various types of voice processing on the voice data received by the receiver 132. For example, the voice processor 140 performs typical voice processing, such as codec processing and noise cancellation (NC) processing, on the voice data received by the receiver 132. Further, the voice processor 140 also performs typical voice processing, such as codec processing and echo cancellation (EC) processing, on the voice data acquired by the voice acquisition unit 138.

The voice output unit 142 converts the voice data (the voice data that has been voice-processed by the voice processor 140) received by the receiver 132 into an analog signal and reproduces voice (i.e., a voice at another location) based on the voice data to output the voice from the loudspeaker 104.

The functions of the IWB 100 described above are each implemented, for example, by a CPU of the system control 105 executing a program stored in the auxiliary storage 106 of the IWB 100. This program may be provided as being preliminarily introduced into the IWB 100 or may be externally provided to be introduced into the IWB 100. In the latter case, the program may be provided by an external storage medium (e.g., USB memory, memory card, CD-ROM, etc.) or may be provided by being downloaded from a server over a network (e.g., Internet, etc.). Of the above-described functions of the IWB 100, some of the functions (e.g., some or all of the functions of the video processor 150, the encoder 128, the decoder 134, or the like) may be implemented by a dedicated processing circuit provided separately from the system control 105.

### Procedure for Video Conference Execution Control Processing by IWB 100

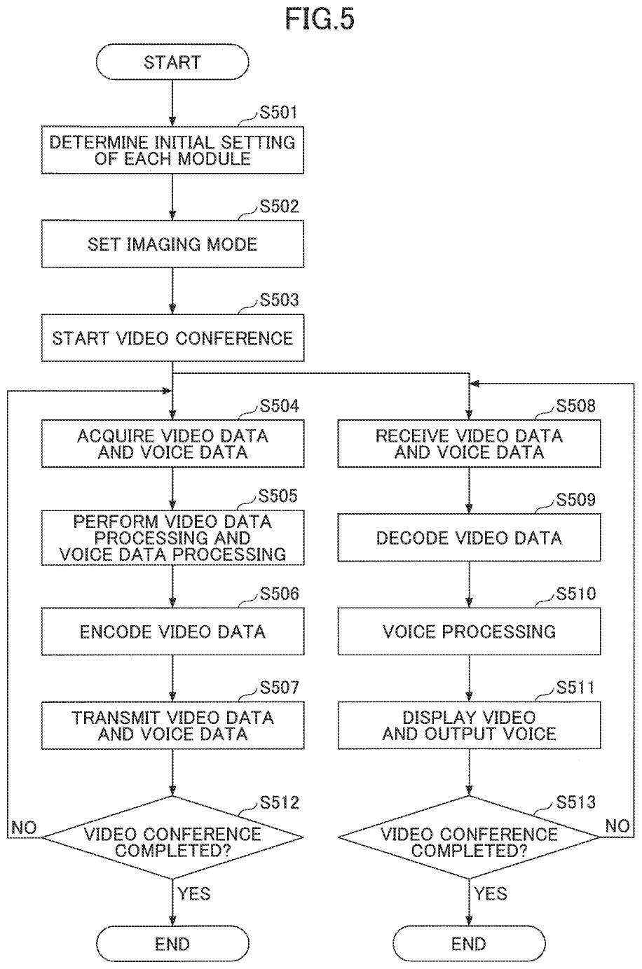

FIG. 5 is a flowchart illustrating a procedure for video conference execution control processing by the IWB 100 according to an embodiment of the present invention.

First, in step S501, the main controller 120 determines an initial setting of each module, and enables the camera 101 to be ready to capture an image. Next, in step S502, the main controller 120 sets an imaging mode of the camera 101. The method of setting the imaging mode by the main controller 120 may include an automatic setting determined based on outputs of various sensors, and a manual setting input by an operator's operation. The main controller 120 transmits a communication start request to an IWB 100 at another location to start a video conference in step S503. Note that the main controller 120 may start the video conference upon receiving of a communication start request from another IWB 100. The main controller 120 may also start recording of a video and voice by the recording device 110 at the same time as the video conference is started.

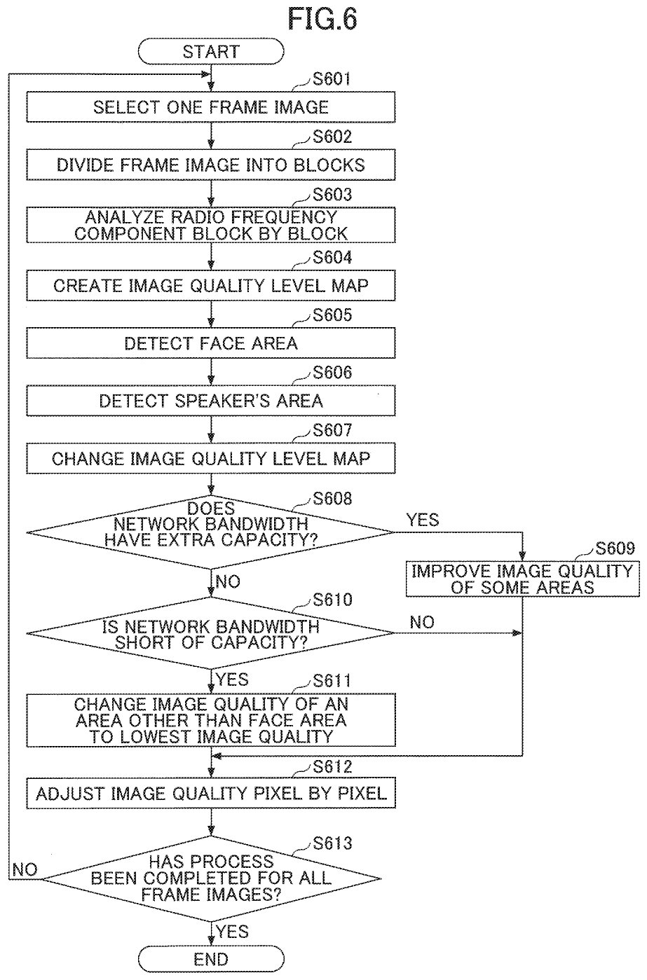

Upon starting of the video conference, the video acquisition unit 122 acquires video data (YUV data) from the camera 101, and the voice acquisition unit 138 acquires voice data from the microphone 103 in step S504. In step S505, the video processor 150 performs video processing (described in detail in FIG. 6) on the video data acquired in step S504, and the voice processor 140 performs various voice processing on the voice data acquired in step S504. In step S506, the encoder 128 encodes the video data that has been video-processed in step S505. In step S507, the transmitter 130 transmits the video data encoded in step S506 to an external apparatus such as another IWB 100 through a network 16 together with the voice data acquired in step S504.

In parallel with steps S504 to S507, the receiver 132 receives the video data and voice data transmitted from another IWB 100 through the network 16 in step S508. The decoder 134 decodes the video data received in step S508. In step S510, the voice processor 140 performs various types of voice processing on the voice data received in step S508. In step S511, the display controller 136 displays a video on the touch panel display 102 based on the video data decoded in step S509, and the voice output unit 142 outputs a voice from the loudspeaker 104 based on the voice data that has been voice-processed in step S510. In step S511, the display controller 136 may further display a video (i.e., a video at the location of the IWB itself) on the touch panel display 102, based on the video data acquired in step S504.

Following the transmission processing in steps S504 to S507, the main controller 120 determines whether the video conference is completed in step S512. Following the reception processing in steps S508 to S511, the main controller 120 determines whether the video conference is completed in step S513. The completion of the video conference is determined, for example, in response to a predetermined completion operation performed by a user of any of the IWBs 100 that have been joining the video conference. In step S512, when the main controller 120 determines that the video conference has not been completed (step S512: No), the IWB 100 returns the processing to step S504. That is, the transmission processing of steps S504 to S507 is repeatedly performed. In step S513, when the main controller 120 determines that the video conference has not been completed (step S513: No), the IWB 100 returns the processing to step S508. That is, the reception processing of steps S508 to S511 is repeatedly performed. In step S512 or step S513, when the main controller 120 determines that the video conference has been completed (step S512: Yes or step S513: Yes), the IWB 100 ends a series of processing illustrated in FIG. 5.

### Procedure for Video Processing by Video Processor 150

FIG. 6 is a flowchart illustrating a procedure for video processing performed by a video processor 150, according to an embodiment of the present invention. FIG. 6 illustrates in detail a procedure for video processing in step S505 in the flowchart of FIG. 5.

First, in step S601, the blocking unit 151 selects, from among multiple frame images constituting the video data, a single frame image in the order from the oldest frame image. In step S602, the blocking unit 151 divides the single frame image selected in step S601 into multiple blocks.

Next, in step S603, the video analyzer 152 analyzes high frequency components, for each of blocks that have been divided in step S602, with respect to the single frame image selected in step S601.

In step S604, with respect to the single frame image selected in step S601, the image quality determination unit 153 sets an image quality for each of the blocks divided in step S602 based on an analysis result of the high frequency components obtained in step S603 so as to generate an image quality level map.

Next, in step S605, the specific area detector 154 detects one or more of face areas where a face of a person is displayed in the single frame image selected in step S601. Further, in step S606, the specific area detector 154 detects a speaker's area where a face of a person who converses is displayed, from among the face areas detected in step S605.

In step S607, the image quality determination unit 153 changes the image quality level map generated in step S604, based on the detection result of the face area in step S605 and the detection result of the speaker's area in step S606. For example, in the image quality level map generated in step S604, the image quality determination unit 153 changes the image quality of a face area that is a speaker's area to “A (highest image quality)”, and also changes the image quality of a face area that is not a speaker's area to “B (high image quality)”. In addition, with respect to the image quality level map generated in step S604, the image quality determination unit 153 changes an image quality of an area that is not a peripheral area around the speaker's area to “D (low image quality)” without changing an image quality of the peripheral area around the speaker's area.

Next, in step S608, the image quality determination unit 153 determines whether a network bandwidth used for a video conference has extra capacity. In step S609, when the image quality determination unit 153 determines that a network bandwidth has extra capacity (step S608: Yes), the image quality determination unit 153 changes the image quality level map to improve an image quality of a part of the areas. For example, the image quality determination unit 153 may change an image quality of the face area that is not the speaker's area from “B (high image quality) to “A (highest image quality)”, and may return an image quality of an area that is not the peripheral area around the speaker's area to the image quality set in the image quality level map originally generated in step S604. Then, the video processor 150 progresses the processing to step S612.

Meanwhile, in step S610, when the image quality determination unit 153 determines that a network bandwidth used for a video conference does not have extra capacity (step S608: No), the image quality determination unit 153 determines whether the network bandwidth is short of capacity. When the image quality determination unit 153 determines that the network bandwidth is short of capacity (step S610: Yes), the image quality determination unit 153 changes an image quality of other areas excluding the face area to “D (low image quality)” in step S611. Then, the video processor 150 progresses the processing to step S612.

Meanwhile, in step S610, when the image quality determination unit 153 determines that a network bandwidth is not short of capacity (step S610: No), the video processor 150 progresses the processing to step S612.

In step S612, the image quality adjuster 155 adjusts an image quality, pixel by pixel, with respect to the frame image selected in step S601, according to the final image quality level map.

Thereafter, in step S613, the video processor 150 determines whether the above-described video processing has been performed for all the frame images constituting the video data. In step S613, when the video processor 150 determines that the video processing has not been performed for all of the frame images (step S613: No), the video processor 150 returns the processing to step S601. Meanwhile, in step S613, when the video processor 150 determines that the video processing has been performed for all of the frame images (step S613: Yes), the video processor 150 ends a series of processing illustrated in FIG. 6.

### Specific Example of Video Processing by Video Processor 150

FIGS. 7A to 7C and FIGS. 8A to 8D are diagrams illustrating specific examples of video processing by the video processor 150 according to an embodiment of the present invention. The frame image 700 illustrated in FIG. 7A and 7C represents examples of a frame image that is subjected to video processing by the video processor 150.

First, as illustrated in FIG. 7A, the frame image 700 is divided into multiple blocks by the blocking unit 151. In the example illustrated in FIG. 7A, the frame image 700 is divided into 48 blocks (8×6 blocks).

Next, in the frame image 700, the video analyzer 152 analyzes high frequency components for each of the multiple blocks. In the example illustrated in FIG. 7A, one of “0” to “3” represents a corresponding one of levels of high frequency components for each block, as an analysis result of the high frequency components. In this case, a relationship between levels of high frequency components is represented by ‘“3”>“2”>“1”>“0”’.

Next, the image quality determination unit 153 generates an image quality level map corresponding to the frame image 700. An image quality level map 800 illustrated in FIG. 7B is formed by the image quality determination unit 153, based on the analysis result of the high frequency components illustrated in FIG. 7A. According to the example of the image quality level map 800 illustrated in FIG. 7B, one of the image quality levels of “A (highest image quality)”, “B (high image quality)”, “C (intermediate image quality)”, and “D (low image quality)” is set as an image quality for each of the blocks. The image quality levels of “A”, “B”, “C”, and “D” correspond to levels of the high frequency components of “3”, “2”, “1”, and “0”, respectively.

Next, the specific area detector 154 detects, from the frame image 700, one or more of face areas where a face of a person is displayed. Further, the specific area detector 154 detects, from among the face areas detected from the frame image 700, a speaker's area where a face of a person who converses is displayed. In the example illustrated in FIG. 7C, face areas 710 and 712 are detected from the frame image 700. Of these, the face area 710 is detected as a speaker's area.

Subsequently, the image quality determination unit 153 changes the image quality level map 800 based on the detection results of the face areas 710 and 712. According to the example illustrated in FIG. 8A, the image quality determination unit 153 changes the image quality of the face area 710 that is a speaker's area to “A (highest image quality)”, and also changes the image quality of the face area 712 that is not the speaker's area to “B (high image quality)”, with respect to the image quality level map 800 illustrated in FIG. 7B. According to the example illustrated in FIG. 8A, the image quality determination unit 153 changes an image quality of an area that is not a peripheral area around the face area 710 to “D (low quality)”, without changing the image quality of the peripheral area around the face area 710. Note that the area that is not the peripheral area around the face area 710 indicates another area (hereinafter, referred to as a “background area 720”) excluding the face areas 710 and 712. Note that the face area 710 is defined as a first specific area in which a face of a person who converses is displayed, and the face area 712 is defined as a second specific area in which a face of a person who does not converse is displayed.

Further, when the image quality determination unit 153 determines that the network bandwidth used during the video conference has extra capacity, the image quality determination unit 153 changes the image quality level map 800 to improve the image quality of a part of the areas.

For example, in the example of the image quality level map 800 illustrated in FIG. 8B, the image quality determination unit 153 changes the image quality of the face area 712 from “B (high image quality) to “A (highest image quality)”.

Further, in the example of the image quality level map 800 illustrated in FIG. 8C, the image quality determination unit 153 returns the image quality of the areas excluding the peripheral area around the speaker's area in the background area 720 from the image quality of “D (low image quality)” to the initially set image quality illustrated in FIG. 7B.

Conversely, when the image quality determination unit 153 determines that a network bandwidth used in the video conference is short of capacity, the image quality determination unit 153 changes the image quality of the background area 720 to “D (low image quality)” in the image quality level map 800, as illustrated in FIG. 8D.

The image quality adjuster 155 performs image quality adjustment on the frame image 700 pixel by pixel, based on the final image quality level map 800 (any of the image quality level maps illustrated in FIGS. 7B, and FIGS. 8A to 8D).

Accordingly, in the frame image 700, a relatively high image quality is set in the face areas 710 and 712, which attract relatively high attention from viewers, and a relatively low image quality is set in the background area 720, which attracts relatively low attention from the viewers.

However, according to the analysis result of the high frequency components in the frame image 700, the background area 720 includes relatively high image quality settings for areas where image quality deterioration is relatively conspicuous (areas with a large amount of high frequency components, such as an area where a window blind is), and relatively low image quality settings for areas where image quality deterioration is relatively inconspicuous (areas with a small amount of high frequency components, such as walls and displays). In the frame image 700, the image quality deterioration in the background area 720 will thus be inconspicuous.

Further, in the frame image 700, the image quality of the background area 720 gradually changes by block units in a spatial direction. As a result, in the frame image 700, the difference in image quality at an interface between a relatively high image quality setting area and a relatively low image quality setting area in the background area 720 thus becomes inconspicuous.

In the IWB 100 according to the present embodiment, the amount of video data will be reduced, and at the same time, the difference in image quality at the interface between the low quality area and the high quality area will be inconspicuous.

While the preferred embodiments of the invention have been described in detail above, the invention is not limited to these embodiments, and various modifications or variations are possible within the scope of the invention as defined in the appended claims.

For example, the above-described embodiments use the IWB 100 (Interactive Whiteboard) as examples of the “video processing apparatus” and the “communication terminal”; however the present invention is not limited thereto. For example, the functions of the IWB 100 described in the above embodiments may be implemented by other information processing apparatuses (e.g., smartphones, tablet terminals, notebook computers, etc.) with an imaging device, or may be implemented by other information processing apparatuses (e.g., personal computers, etc.) without an imaging device.

Further, although the above-described embodiments describe an example of applying the invention to a video conference system, the present invention is not limited thereto. That is, the present invention may be applicable to any application where the purpose of the present invention is to reduce the amount of data by lowering the quality of a portion of the video data. The present invention may also be applicable to an information processing apparatus that does not perform encoding and decoding of video data.

Moreover, the above-described embodiments use the face detecting area as an example of the “specific area”, but the present invention is not limited thereto. That is, the “specific area” may be any area preferably having a relatively high image quality in which a subject (e.g., a document illustrating a text or image, a whiteboard, a person monitored by a surveillance camera, etc.) is displayed.

The present invention enables to make the difference in image quality between the low quality area and the high quality area inconspicuous while reducing the amount of video data.

In the above-described embodiment, various setting values (e.g., type of subject to be detected in a specific area, block size when dividing a frame image, number of blocks, number of steps in the analysis result of a high frequency component, number of image quality levels, adjustment items in the image quality adjustment, adjustment amount, etc.) set in each process may be predetermined, and suitable values may be optionally set from an information processing apparatus (e.g., a personal computer) provided with a user interface.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.)

The hardware platform includes any desired kind of hardware resources including, for example, a central processing unit (CPU), a random access memory (RAM), and a hard disk drive (HDD). The CPU may be implemented by any desired kind of any desired amount of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

The present invention is not limited to the specifically disclosed embodiments, and variations and modifications may be made without departing from the scope of the present invention.

What is claimed is:

1. A video processing apparatus comprising:
a memory; and
one or more processors coupled to the memory, the one or more processors being configured to:
acquire a video;
analyze high frequency components, for each of areas of the acquired video; and
perform image quality adjustment, in accordance with an analysis result of the high frequency components, such that an image quality of at least a part of the areas of the video increases as an amount of high frequency components in the at least part of the areas of the video increases.

2. The video processing apparatus according to claim 1, wherein the one or more processors are further configured to:
divide the video into a plurality of blocks;
analyze the high frequency components for a block of the plurality of blocks of the video; and
perform the image quality adjustment on the block.

3. The video processing apparatus according to claim 1, wherein the one or more processors are further configured to:
detect a specific area of the video, the specific area being an area in which a specific subject in the video is displayed; and
perform the image quality adjustment such that an image quality of the specific area is higher than an image quality of another area excluding the specific area.

4. The video processing apparatus according to claim 3,
wherein the another area includes a peripheral area around the specific area, and
wherein the one or more processors are further configured to perform the image quality adjustment such that an image quality of the peripheral area around the specific area is determined in accordance with the analysis result, and such that an image quality of an area excluding the peripheral area around the specific area is lower than the image quality of the peripheral area determined in accordance with the analysis result.

5. The video processing apparatus according to claim 3, wherein the one or more processors are further configured to:
encode the video on which the image quality adjustment has been performed; and
transmit the encoded video to an external apparatus.

6. The video processing apparatus according to claim 5, wherein the one or more processors are further configured to:
perform the image quality adjustment such that the image quality of the another area is set to a lowest image quality, in response to communication resources used in the transmitting of the encoded video being short of capacity.

7. The video processing apparatus according to claim 5, wherein the one or more processors are further configured to:
perform the image quality adjustment such that the image quality of the specific area is set to a highest image quality, in response to communication resources used in the transmitting of the encoded video having extra capacity.

8. The video processing apparatus according to claim 5, wherein the one or more processors are further configured to:
perform the image quality adjustment such that the image quality of the another area increases, in response to communication resources used in the transmitting of the encoded video having extra capacity.

9. The video processing apparatus according to claim 3, wherein the one or more processors are further configured to:
detect the specific area as an area in which a face of a person in the video is displayed.

10. The video processing apparatus according to claim 9,
wherein the specific area includes a first specific area and a second specific area, the first specific area being an area in which a face of a person who converses is displayed, and the second specific area being an area in which a face of a person who does not converse is displayed, and
wherein the one or more processors are further configured to perform the image quality adjustment such that an image quality of the second specific area is lower than an image quality of the first specific area.

11. A video conference system comprising:
a plurality of communication terminals configured to perform a video conference; and
a server apparatus configured to perform various types of controls relating to the video conference performed by the plurality of communication terminals, wherein each of the plurality of communication terminals includes
a memory; and
one or more processors coupled to the memory, the one or more processors being configured to:
capture a video;
analyze high frequency components, for each of areas of the captured video;
perform image quality adjustment, in accordance with an analysis result of the high frequency components, such that an image quality of at least a part of the areas of the video increases as an amount of high frequency components in the at least part of the areas of the video increases; and
transmit, to an external apparatus, the video on which the image quality adjustment has been performed.

12. A video processing method comprising:
acquiring a video;
analyzing high frequency components, for each of areas of the acquired video; and
performing image quality adjustment, in accordance with an analysis result of the high frequency components, such that an image quality of at least a part of the areas of the video increases as an amount of high frequency components in the at least part of the areas of the video increases.
